(19) United States
(12) Patent Application Publication
(10) Pub. No.: US 2017/0169464 A1
(43) Pub. Date: Jun. 15, 2017

(54) DETERMINING VIEWER'S EXPOSURE TO VISUAL MESSAGES

(71) Applicant: Ofer MILLER, Savyon (IL)

(72) Inventor: Ofer MILLER, Savyon (IL)

(21) Appl. No.: 15/071,117

(22) Filed: Mar. 15, 2016

(30) Foreign Application Priority Data
Dec. 10, 2015 (SG) 10201510151Q

(51) Int. Cl. G06Q 30/02; H04N 21/258; H04N 21/61; H04N 21/45; H04N 21/442; H04N 21/81

(52) U.S. Cl. CPC G06Q 30/0246; G06Q 30/0261; H04N 21/44204; H04N 21/812; H04N 21/6125; H04N 21/4532; H04N 21/25883

(57) ABSTRACT

A method is provided for determining number of times in which a specific advertisement is displayed to a specific viewer on digital billboards. The method comprises: providing data which relates to geographical locations of the digital billboards and a displaying time when that advertisement was displayed thereat; retrieving data relating to a group of viewers who were present within a viewing range from a respective digital billboard at the time the advertisement was displayed thereat; determining whether the viewer is included among this group of viewers; and if so, storing information that relates to that determination. Also provided is a method for preventing display of a specific advertisement to the viewer if the total number of times in which that advertisement has already been displayed to that viewer on different displaying means, is equal to a pre-determined value.

### TECHNICAL FIELD

The present invention relates in general to the field of incorporating visual messages within video signals, and in particular to methods for tracking a viewer's exposure to visual messages.

### BACKGROUND

Online advertising is moving in the direction of highly personalized advertisements based on one's activities, social relationships and profile information. According to figures released in the Interactive Advertising Bureau (“IAB”) Internet Advertising Revenue Report, online advertising is thriving in the US as well as in the rest of the world and estimations are that the relative share of online advertising based on social network websites will increase persistently.

In general, there are several types of advertisements used in the Internet. One such type is the flash-video ads. Flash advertisements are short video clips that are displayed in conjunction with a requested video clip. This kind of advertising is similar to advertising in the television, and many advertisers use the same clips for both television and online flash player.

In recent years, the use of an ad server has been increasingly growing. An ad server is a computer server, typically a web server backed by a database server, that stores advertisements for online advertising and delivers them to website visitors. The content of the webserver is constantly updated so that the website or webpage on which the ads are displayed contains new advertisements such as banners (static images/animations) or text—when the site or page is visited or refreshed by a user. The purpose of ad serving is to deliver ads to users, to manage a websites advertising space and (in the case of advertiser ad servers) to provide an independent counting and tracking system for advertisers.

Ad serving also performs various other tasks like counting the number of impressions/clicks for an ad campaign and report generation, which in turn is used in determining the ROI for an advertiser on a particular website.

Ad servers can be run locally or as remote ad servers. Local ad servers are typically run by a single publisher and serve advertisements that are incorporated in that publisher's domains, allowing fine-grained creative, formatting, and content control by that publisher. Remote ad servers on the other hand can serve ads across domains owned by multiple publishers. They deliver the ads from one central source so that advertisers and publishers may track the distribution of their online advertisements, and have one location for controlling the rotation and distribution of their advertisements across the web.

One aspect of ad-serving technology is the use of automated and semi-automated means for optimizing bid prices, placement, targeting, or other characteristics. These goals may are achieved by implementing the following methods:
Behavioral targeting: using a profile of the viewer's prior behavior to determine which ad should be displayed to him during a given visit at the website. For example, targeting car ads on a portal to a viewer that is known to have visited the automotive section of a general media site.
Contextual Targeting: inferring the optimum ad placement from information contained on the page where the ad is being displayed. For example, placing garden tools' ads automatically on a page with a gardening methods' article.
Creative Optimization: using experimental or predictive methods to explore the optimum creative for a given ad placement and exploiting that determination in future opportunities.

Mobile advertising may be considered as a somewhat related technology to online or internet advertising, though its reach is far greater—currently, most mobile advertising is targeted at mobile phones, that came estimably to a global total of $4.6bn as of 2009. Notably computers, including desktops and laptops, are currently estimated at 1.1 billion globally. Moreover, mobile advertising includes SMS and MMS advertising units in addition to the advertisement types served and processed via online channels.

As mobile advertising matures, like in the most advanced markets, the user involvement also matures. In Japan today, over 44% of mobile phone owners click on ads they receive on their phones.

One of the Internet advertising model, used when traffic is directed to a desired website, is pay per click (“PPC”), in which advertisers pay the publisher (typically a website owner or a host of website) when the ad is clicked by a viewer. It may simply be regarded as the costs spent in order to get an advertisement clicked. With search engines, advertisers typically bid on keyword phrases relevant to their target market. However, content sites commonly charge a fixed price per click rather than use a bidding system.

In contrast to the generalized portal, which seeks to drive a high volume of traffic to one site, PPC implements a so-called affiliate model, which provides purchase opportunities wherever people may be surfing. It does this by offering financial incentives (in the form of a percentage of revenue) to affiliated partner sites. The affiliates provide purchase-point click-through to the merchant. It is a pay-for-performance model: If an affiliate does not generate sales, it represents no cost to the merchant. Variations include banner exchange, pay-per-click, and revenue sharing programs.

Websites that utilize PPC ads will display an advertisement when a keyword query matches an advertiser's keyword list, or when a content site displays relevant content. Such advertisements are called sponsored links or sponsored ads, and appear adjacent to, above, or beneath the actual results displayed on search engine results pages.

The PPC advertising model is open to abuse through click fraud, although certain companies have implemented automated systems to guard against abusive clicks by competitors or corrupt web developers.

However, as the ad market is constantly developing towards targeted advertisements, there are some problems associated with that trend. The present invention seeks to provide a solution to some of these problems.

### SUMMARY OF THE DISCLOSURE

The disclosure may be summarized by referring to the appended claims.

It is an object of the present invention to provide methods and computer program products to allow obtaining information that relate to viewers of a certain visual message such as an advertisement.

It is another object of the present invention to provide methods and computer program products to allow obtaining information that relate to viewers watching advertisements being displayed on billboards.

It is still another object of the present invention to provide methods, computer program products for obtaining information that relate to the number of times a certain viewer was subjected to a certain visual message such as an advertisement.

Other objects of the present invention will become apparent as the description of the invention proceeds.

In one embodiment, there is provided a method for determining number of times in which a specific viewer was provided with an opportunity to watch a specific visual message (such as an advertisement) displayed at one or more street digital billboards, wherein the method comprises the steps of:

providing data which relates to geographical locations of the one or more digital billboards configured to display the specific visual message, and a displaying time when said specific visual message is displayed at each of the one or more digital billboards;

retrieving data which relates to a group of viewers whose geographical locations at the time when the specific visual message was displayed at a specific digital billboard from among the one or more digital billboards, are within a viewing range from the geographical location of the specific digital billboard;

determining whether the specific viewer is included among the group of viewers; and

if the specific viewer is determined to be among the group of viewers, storing information associated with that determination.

The term “visual message” as used herein and throughout the description and claims should be understood to encompass a text message, an image, an advertisement, an animated advertisement, a banner and/or a video clips.

According to another embodiment, the data which relates to the geographical location of the specific digital billboard, comprises information that allows determining a geographical zone at which the specific visual message, when displayed, may be viewed by viewers who are present within that geographical zone. For example, such data may relate to the direction at which the display of the digital billboard, faces, so that viewers whose geographical location is at the proximity of that digital billboard but cannot view its display (e.g. if they are behind that digital billboard), will not be included in that group of viewers.

In accordance with another embodiment, the retrieved data relate to viewers that are within the geographical zone.

By yet another embodiment, the determination that the specific viewer is included among the group of viewers to whom the retrieved data relates, is derived from a Global Positioning System (GPS).

According to still another embodiment, there is provided a method for determining number of times in which a specific viewer is provided with an opportunity to watch a specific visual message, which comprises the steps described hereinabove for determining number of times in which a specific viewer was provided with the opportunity to watch that specific visual message displayed at one or more street digital billboards, and further comprising the step of:

retrieving information that relates to a number of times that the specific viewer was presented with said specific visual message after entering one or more websites.

According to another embodiment, the retrieved information is derived from one or more of the following sources: communication routers, communication switches, Internet Service Providers' databases, Internet websites and a Global Positioning System (GPS).

In accordance with another embodiment, the method provided is used to synchronize exposures opportunities which a specific viewer is subjected with the possibility to watch a certain visual message (e.g. an advertisement), when these opportunities are presented to the viewer at at least two different displays selected from among a group the consists of: one or more websites accessed by the viewer using a computer, one or more websites accessed by the viewer using a mobile telephone, digital television broadcast (IPTV), and a digital street billboard.

In accordance with another aspect of the invention, there is provided a method for preventing display of a specific visual message to a specific viewer, wherein the method comprises the steps of:

providing a value of a frequency cap which defines a maximum number of times that the specific visual message should be displayed to a viewer;

determining the total number of times in which the specific visual message has already been displayed to the specific viewer on different devices (e.g. computer, laptop, mobile phone, digital billboard, etc.); and

if the total number of times in which the specific visual message has already been displayed to the specific viewer is equal to the value of the frequency cap provided, preventing future display of that specific visual message to that specific user at any website which that specific user will access.

In accordance with another embodiment of this aspect, the method further comprising a step of determining the number of times in which the specific visual message has already been displayed to the specific viewer while incorporated in an IPTV broadcast.

According to another embodiment of this aspect of the invention, the method provided further comprises a step of determining the number of times in which the specific visual message has already been displayed to the specific viewer at one or more websites which were accessed by the specific viewer.

By still another embodiment, the total number of times is derived from the number of times the specific visual message was displayed to the specific viewer at each one of the following media sources: one or more Internet websites, IPTV and one or more digital billboards.

In accordance with another embodiment, there is provided a method for determining a number of exposure opportunities provided to a specific viewer to watch a specific visual message, when the opportunities are presented to the viewer at at least two different displays selected from among a group the consists of: a computer (desk top and/or laptop) screen, a mobile telephone screen, a TV screen when displaying a digital television (IPTV) broadcast, and a digital street billboard. Thus, by synchronizing the information obtained from these various sources, it is possible for example to control the number of times in which a certain advertisement will be displayed to a specific user.

According to still another aspect of the invention there is provided a computer program product encoding a computer program stored on a non-transitory computer readable storage medium for executing a set of instructions by a computer system comprising one or more computer processors for carrying out a method for preventing display of a specific visual message to a specific viewer, said method comprising the steps of:

receiving a value of a frequency cap which defines a maximum number of times that the specific visual message should be displayed to a viewer;

receiving data which relates to geographical locations of one or more digital billboards configured to display the specific visual message, and times at which the specific visual message has been displayed at each of the one or more digital billboards;

receiving data which relates to a group of viewers whose geographical locations at the time when the specific visual message has been displayed at the one or more digital billboards, were within a viewing range from the geographical location of a respective digital billboard;

determining whether the specific viewer is included among said group of viewers;

for each time that the determination made is that the specific viewer was among the group of viewers, increasing the value of a viewing counter that is specific to (e.g. associated with) both the specific viewer and the specific visual message (e.g. increasing by 1);

receiving information that relates to a number of times that the specific viewer was presented with the specific visual message after entering one or more websites, and increasing the value of the viewing counter (e.g. by the value of 1) for each such time; and

checking the value of the viewing counter and once that value is equal to the pre-defined value of the frequency cap, preventing future display of that specific visual message to that specific user at any website to which that specific user will enter.

According to another embodiment of this aspect of the invention, the method further comprising receiving information that relates to a number of times that the specific viewer was presented with the specific visual message when watching IPTV broadcasts, and increasing the value of the viewing counter for each such time.

### BRIEF DESCRIPTION OF THE DRAWINGS

FIG. 1—illustrates a flow chart exemplifying a method for carrying out an embodiment of the invention for determining the number of times in which a viewer is provided with an opportunity to watch a specific advertisement displayed on street digital billboards; and

FIG. 2—illustrates a flow chart exemplifying a method for carrying out another embodiment of the invention for determining the number of times in which a viewer is provided with an opportunity to watch a specific advertisement on a plurality of different media displaying means.

### DETAILED DESCRIPTION

A better understanding of the present invention will now be obtained when the following non-limiting detailed description is considered in conjunction with the following drawings.

Advertising campaigns are becoming more and more targeted campaigns, where certain advertisements are matched to specific viewers based on data retrieved from the viewers' own personal profile. In addition, it has been established that the effectiveness of advertisements is a decreasing function of the number of times the viewer is subjected to a certain advertisement. In other words, the effectiveness of an advertisement which the viewer watches for the first time, is by far greater than the effectiveness of an advertisement which the viewer watches say for the tenth time.

Therefore, one of the questions that is increasingly being asked in nowadays campaigns is, how to limit the maximum number of times that a certain viewer is subjected to a specific advertisement (referred to hereinafter as “frequency cap”), where this parameter, the frequency cap, may be different from one advertisement to another.

Unfortunately, prior art solutions provide only a very partial answer to this question. At best, the prior art solutions provide the number of times that a user accessed a certain website (or a number of websites) in which the advertisement was displayed to him/her (e.g. in response to identifying that the profile of that user is such that the advertisement should be displayed to him, while surfing that website). However, there is no one single solution that enables aggregating the number of times that a viewer was subjected to a specific advertisement displayed to him by a variety of different displaying means, in order to synchronize the information retrieved from the different sources to ensure that the advertiser does not pay for displaying the advertisement to the specific user, if the frequency cap defined for that advertisement has already been reached by that viewer.

When considering the message conveyed by an advertisement, a typical viewer is indifferent to the displaying means at which he/she watched that advertisement. Therefore, the required solution is one that synchronizes the information retrieved from the different sources in order to establish the aggregated number of times a specific viewer had the opportunity to watch a specific advertisement.

One example of such type of a displaying mean which is not taken into account in all prior art solutions is the electronic billboards that are placed on the streets, showing different advertisements. As may be appreciated by those skilled in the art, if a viewer passes one or more electronic billboards every day when a specific advertisement is displayed, say on his way to work, obviously, the frequency cap for that advertisement will be reached rather quickly, and there will be no need to display that advertisement for him on a different displaying means, e.g. his mobile phone.

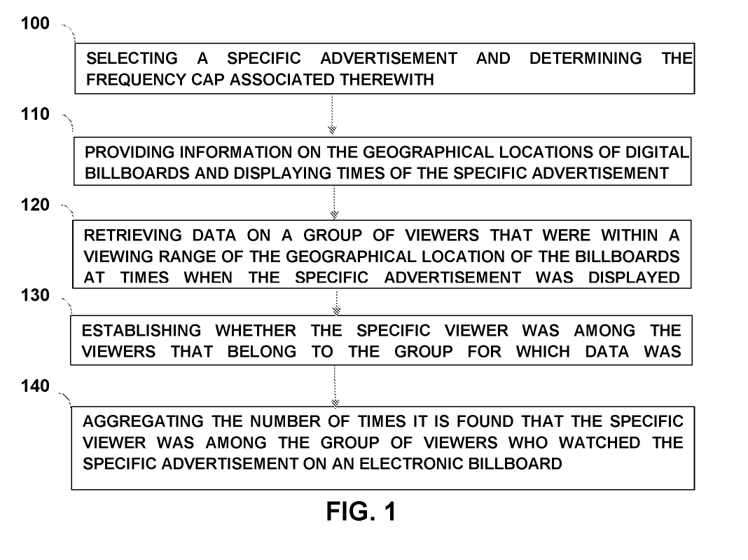

FIG. 1 illustrates a flow chart exemplifying a method for carrying out an embodiment of the invention for determining the number of times in which a certain person (a viewer) was provided with an opportunity to watch a specific visual message such as an advertisement, displayed on street digital billboards. For the convenience of the reader, the visual message hereinabove will be considered as an advertisement, but it should be understood that other types of visual messages may be used such as text messages, images, animated advertisements, banners, video clips, and the like.

Step 100 of the method exemplified in the flow chart of FIG. 1, comprises selecting a specific advertisement and determining the frequency cap associated therewith. This association of the specific advertisement and its frequency cap is received by a processor of a system that is used for carrying out this embodiment, and stored at a storage of that system.

Next, providing information on the geographical locations of digital billboards on which the specific advertisement will be displayed, and the advertisement's displaying times, on each of these billboards (step 110). This information may either be provided based on future scheduling of the display, or based on the actual display of the specific advertisement on each of these digital billboards after their occurrence. The information provided is also received by the system's processor and stored at the storage means.

The data provided, relates preferably to a geographical zone wherein the advertisements, when displayed on the respective digital billboard, may be viewed by viewers who are present within that geographical zone. As already explained, such data may relate to the direction which the display of the digital billboard faces, so that viewers who are present at the time when the advertisement was displayed, and are within a pre-defined distance from the digital billboard but still cannot watch its display (e.g. if they are behind that digital billboard), will not be included in that group of viewers.

The next step, step 120, involves retrieving data that relate to a group of viewers that were present within a viewing range from the geographical location of each of the digital billboards, at the time when the specific advertisement was displayed on each respective digital billboard (i.e. those who were at the right time and the right place, when the advertisement was displayed on each of the respective electronic billboards). The retrieved data allows identifying the viewers (e.g. by codes that had been assigned to each respective viewer) who may be included within the group of relevant viewers. The received data which may be derived for example from a Global Positioning System (GPS), is stored at the system's storage means.

For the sake of simplicity, let us consider a case where it is required to establish the number of times that a given viewer was provided with the opportunity to watch the specific advertisement. As will be appreciated by those skilled in the art, a similar process to the one described hereinbelow, mutatis mutandis, is likely to be carried out for other viewers who belong to that group of relevant viewers, as well.

After the data that relates to the group of relevant viewers who were identified as ones that were present in the viewing zone while the advertisement was displayed, has been retrieved, a search is initiated by the system's processor (step 130). The purpose of this search is to establish whether the specific viewer was among the viewers who belong to the group of the relevant viewers.

For each time found that the specific viewer was among the group of relevant viewers, the processor increases the value of a viewing counter that is specific to (e.g. associated with) both the specific viewer and the specific visual message (e.g. increased by the value of 1) thereby determining the number of times a specific viewer was provided with the opportunity to watch a specific advertisement on a digital billboard (step 140).

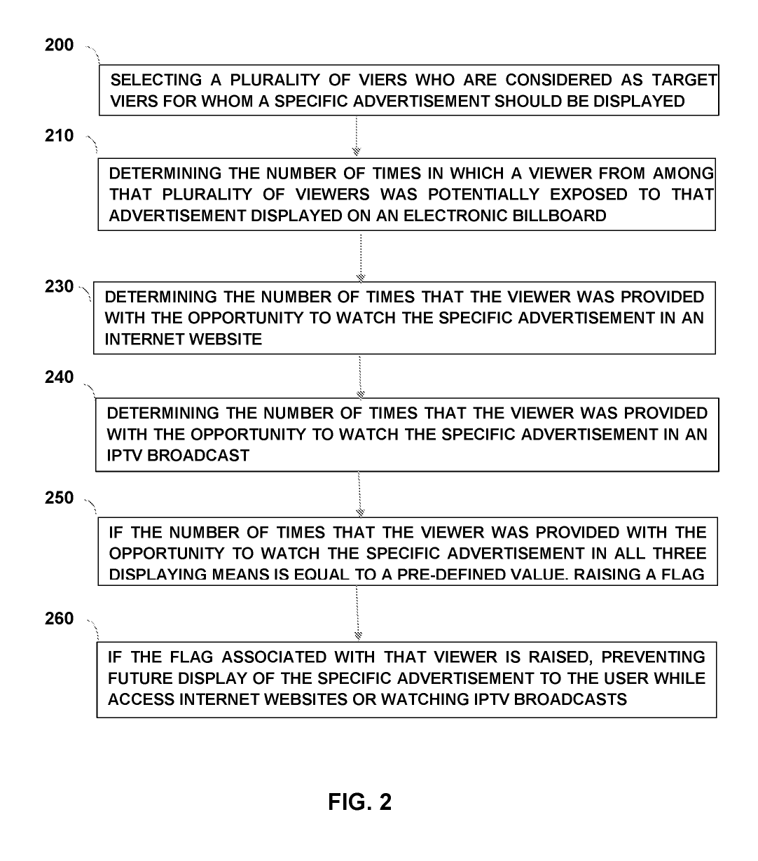

FIG. 2 illustrates a flow chart exemplifying a method for carrying out another embodiment of the invention for determining the number of times in which a specific viewer is provided with an opportunity to watch a specific visual message at a plurality of different media displaying means. In this example, the determination made is used to enable preventing display of a visual message to the viewer, once that viewer was exposed to the visual message (e.g. an advertisement) a pre-defined number of times.

Step 200 comprises selecting a plurality of users who, based on their known profile, are considered as candidates to whom a specific advertisement will be displayed. There are many methods known in the art per se that would allow such matching of the users' profile with the specific advertisement (or with the class to which the specific advertisement belongs), and the present invention should not be considered as being limited to any specific method for such a matching process.

Next, every time that a user who belongs to the plurality of the selected users, is identified as a viewer who was potentially exposed to the specific advertisement when displayed on an electronic billboard (e.g. in a way such as the one described in the previous example), the processor of the system that is used to carry out the present invention, increases the value of a viewing counter that is unique to the specific user and to the specific advertisement, by the value of 1 and stores the updated value of the viewing counter at the system's memory (step 210).

Another media where the user may be provided with the opportunity to watch the advertisement is in an Internet website (or different websites). Once the user whose ID (or IP address) is known, has gained access to a website where he is recognized as a user to whom that specific advertisement should be displayed, and the specific advertisement has indeed been displayed thereat, a message is sent to the system's processor. This message may be sent to the system's processor as an automatic message generated for example by the website owner. Once the message is received by the processor, it increases the value of the viewing counter associated with that specific user by the value of 1 and stores the updated value of the viewing counter at the system's memory (step 220).

In addition, the user may be provided with the opportunity to watch the advertisement while watching a broadcast on an IPTV (Internet Protocol television) which is a system through which television services are delivered using the Internet protocol media over a packet-switched network. In such a case, the user is identified by an IP address, and once the system of the ISP (Internet Service Provider) determines that the IP address associated with the specific user has received a broadcast in which the advertisement was incorporated, based on information derived for example from the ISP router, a message would be sent to the system's processor. This message may be sent to the system's processor as an automatic message generated in response to a query initiated by the system carrying out the present invention, or by the ISP if the latter had been provided in advance with the details that would enable combining the specific user to the specific advertisement. Once the message is received by the processor, it increases the value of the viewing counter associated with that specific user by the value of 1 and stores the updated value of the viewing counter at the system's memory (step 230).

The processor carries out a routine check (i.e. every pre-defined period of time) on the current value of the viewing counter (step 240). Once the value of the viewing counter is found to be equal to the pre-determined value of the frequency cap, the processor will associate a flag with the specific user's record. That flag is used for preventing future display of the specific advertisement to that specific user at the websites to which that specific user will enter (step 250), or optionally, will select a replacement advertisement (instead of the specific advertisement), one that may preferably also match the user's profile, that may be displayed to that user once he accesses websites where the advertisement may be displayed, or be incorporated in the IPTV broadcasts that are conveyed to the IP address associated with that user (step 260).

In the description and claims of the present application, each of the verbs, “comprise” “include” and “have”, and conjugates thereof, are used to indicate that the object or objects of the verb are not necessarily a complete listing of members, components, elements or parts of the subject or subjects of the verb.

The present invention has been described using detailed descriptions of embodiments thereof that are provided by way of example and are not intended to limit the scope of the invention in any way. The described embodiments comprise different features, not all of which are required in all embodiments of the invention. Some embodiments of the present invention utilize only some of the features or possible combinations of the features.

Variations of embodiments of the present invention that are described and embodiments of the present invention comprising different combinations of features noted in the described embodiments will occur to persons of the art. For example, reference was made in the description to detecting the number of times that a visual message was provided to a specific user. However, it should be understood that the methods provided may also be implemented on a vast number of users, while the steps of the disclosed methods are conducted for each of the users, as if that user is the specific user referred to herein. Thus, the scope of the invention is limited only by the following claims.

1. A method for determining number of times in which a specific viewer is provided with an opportunity to watch a specific visual message, the method comprising the steps of:
in case that the number of times that the specific viewer is provided with an opportunity to watch a specific visual message refers to a visual message displayed on one or more digital billboards, the method comprises:
providing data which relates to geographical locations of the one or more digital billboards configured to display the specific visual message, and a displaying time when said specific visual message is displayed at each of the one or more digital billboards;
retrieving data which relates to viewers whose geographical locations at the time when said specific visual message was displayed at a respective digital billboard from among the one or more digital billboards, are within a viewing range from the geographical location of said respective digital billboard;
determining whether the specific viewer is included among said viewers to whom the retrieved data relates; and
if the specific viewer is determined to be among the viewers to whom the retrieved data relate, storing information that relates to that determination.

2. The method of claim 1, wherein the data which relates to the geographical location of the specific digital billboard, comprises information that allows determining a geographical zone at which the specific visual message, when displayed, may be viewed by viewers who are present within that geographical zone.

3. The method of claim 2, wherein the retrieved data relates to viewers that are within the geographical zone.

4. The method of claim 1, wherein the determination that the specific viewer is included among the viewers to whom the retrieved data relates, is derived from a Global Positioning System (GPS).

5. The method of claim 1, further comprising the step of:
retrieving information that relates to number of times that the specific viewer was presented with said specific visual message after entering one or more websites.

6. The method of claim 5, wherein the retrieved information is derived from one or more of the following sources: communication routers, communication switches, Internet Service Providers' databases, Internet websites and a Global Positioning System (GPS).

7. A method for preventing display of a specific visual message to a specific viewer, said method comprising the steps of:
providing a value of a frequency cap which defines a maximum number of times that the specific visual message should be displayed to a viewer;
determining according to the method of claim 5, the number of times in which the specific visual message has already been displayed to the specific viewer on one or more digital billboards; and
if the total number of times in which the specific visual message has already been displayed to the specific viewer is equal to the value of the frequency cap provided, preventing future display of that specific visual message to that specific user at any website to which that specific user will enter.

8. The method of claim 7, further comprising a step of determining the number of times in which the specific visual message has already been displayed to the specific viewer while incorporated in an IPTV broadcast.

9. The method of claim 8, further comprising a step of determining the number of times in which the specific visual message has already been displayed to the specific viewer at one or more websites which were accessed by the specific viewer.

10. The method of claim 9, wherein the total number of times is derived from the number of times the specific visual message was displayed to the specific viewer at each one of the following media sources: one or more Internet websites, IPTV and one or more digital billboards.

11. A method for determining a number of exposure opportunities provided to a specific viewer to watch a specific visual message, when said opportunities are presented to the viewer at at least two different displays selected from among a group the consists of: a computer screen, a mobile telephone screen, a TV screen when displaying a digital television (IPTV) broadcast, and a digital street billboard.

12. A computer program product encoding a computer program stored on a non-transitory computer readable storage medium for executing a set of instructions by a computer system comprising one or more computer processors for carrying out a method for preventing display of a specific visual message to a specific viewer, said method comprising the steps of:
receiving a value of a frequency cap which defines a maximum number of times that the specific visual message should be displayed to a viewer;
receiving data which relates to geographical locations of one or more digital billboards configured to display the specific visual message, and times at which said specific visual message has been displayed at each of the one or more digital billboards;
receiving data which relates to a group of viewers whose geographical locations at the time when said specific visual message has been displayed at the one or more digital billboards, were within a viewing range from the geographical location of a respective digital billboard;
determining whether the specific viewer is included among said group of viewers;
for each time that said determination is that the specific viewer was among the group of viewers, increasing the value of a viewing counter that is specific to both said specific viewer and said specific visual message;
receiving information that relates to a number of times that the specific viewer was presented with said specific visual message after entering one or more websites, and increasing the value of the viewing counter for each such time; and
checking the value of the viewing counter and once said value is equal to the value of the frequency cap, preventing future display of that specific visual message to that specific user at any website to which that specific user will enter.

13. The computer program product of claim 12, wherein the method further comprising receiving information that relates to a number of times that the specific viewer was presented with said specific visual message when watching IPTV broadcasts, and increasing the value of the viewing counter for each such time.
